(19) United States
(12) Patent Application Publication
(10) Pub. No.: US 2007/0091056 A1
(43) Pub. Date: Apr. 26, 2007

(54) LIQUID CRYSTAL DISPLAY DEVICE AND DRIVING METHOD OF THE SAME

(76) Inventors: Mitsutaka Okita, Hakusan-shi (JP); Kazuhiro Nishiyama, Kanazawa-shi (JP); Daiichi Suzuki, Sendai-shi (JP); Shigesumi Araki, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/551,061

(22) Filed: Oct. 19, 2006

(30) Foreign Application Priority Data
Oct. 21, 2005 (JP) 2005-306878

(51) Int. Cl. G09G 3/36

(52) U.S. Cl. 345/102

(57) ABSTRACT

A liquid crystal display device includes a liquid crystal display panel, which includes a pair of substrates and a liquid crystal layer held between the substrates, illumination means for illuminating the panel, and a control unit which controls the panel and the illumination means. The panel includes a plurality of display pixels arrayed in a matrix manner. The control unit includes non-video signal insertion means for cyclically writing a video signal and a non-video signal as pixel voltages in each of the pixels, synchronizing means for synchronizing a turn-on timing or a turn-off timing of the illumination means with a timing at which the video signal or the non-video signal is written in the pixels, and phase control means for changing a turn-on period and the turn-on timing of the illumination means.

### CROSS-REFERENCE TO RELATED APPLICATIONS

This application is based upon and claims the benefit of priority from prior Japanese Patent Application No. 2005-306878, filed Oct. 21, 2005, the entire contents of which are incorporated herein by reference.

### BACKGROUND OF THE INVENTION

1. Field of the Invention

The present invention relates generally to a liquid crystal display device and a method of driving the liquid crystal display device, and more particularly to an OCB (Optically Compensated Bend) mode liquid crystal display device and a method of driving the OCB mode liquid crystal display device.

2. Description of the Related Art

A liquid crystal display device has a liquid crystal display panel which includes a pair of substrates and a liquid crystal layer that is held between the pair of substrates. The liquid crystal display panel has a plurality of display pixels which are arrayed in a matrix manner. Further, a plurality of source lines are disposed along the columns of the display pixels, and a plurality of gate lines are disposed along the rows of the display pixels. In each display pixel, a pixel switch is disposed near an intersection of the associated source line and gate line.

In the case of driving the above-described liquid crystal display device, a state in which an image is displayed is retained during 1 frame period by the pixel switch of each display pixel. Thus, compared to a display device such as a cathode-ray tube (CRT), it is difficult to improve the visibility of a moving image.

In order to improve the moving image visibility, for example, in an OCB mode liquid crystal display device, the high-speed responsivity of the OCB mode is utilized, and it has been proposed to perform a black insertion driving method in which a period for displaying a video signal and a period for displaying a non-video signal, such as black-level signal, are cyclically provided in 1 frame period. In this case, the moving image visibility is improved by increasing the black insertion ratio in 1 frame period by about 40%, and video display, which is substantially equal to that of the CRT, is realized (see, e.g. Jpn. Pat. Appln. KOKAI Publication No. 2002-202491).

However, if the black insertion ratio is increased in order to improve the moving image visibility, the black display period in 1 frame period increases. As a result, in some cases, the white luminance of the display screen lowers, the contrast deteriorates and the power consumption increases. For example, if the black insertion ratio, which is normally 20%, is increased to 40%, the moving image visibility is remarkably improved and the moving image display without unnaturalness is enabled, but the contrast, in some cases, decreases from about 500 to about 340.

Moreover, in the conventional black insertion driving method, the black insertion period for executing black display is provided in 1 frame period in addition to the video signal display period. Consequently, the white luminance lowers. Besides, since the backlight is always turned on despite the black insertion period being provided, useless power consumption occurs.

Under the circumstances, it has been thought to use a blinking backlight scheme, in which backlight is turned off in the black insertion period in 1 frame period, thereby suppressing useless power consumption.

In the liquid crystal display device using both the black insertion driving method and the blinking backlight scheme, a backlight dimming (light control) is used in which the turn-on period of backlight is changed by varying a duty ratio of a dimmer signal by PWM (Pulse Width Modulation).

### BRIEF SUMMARY OF THE INVENTION

The main object of a dimming control of a backlight is to vary the brightness of the backlight. However, when the brightness of backlight is to be adjusted, the contrast of the display screen varies at the same time in some cases. In other words, when the user varies the brightness of the liquid crystal display, the image quality (contrast) of the display also varies in some cases.

The present invention has been made in consideration of the above-described problem, and the object of the invention is to provide a liquid crystal display device and a method of driving the liquid crystal display device, which can suppress variation in contrast of a display image due to dimming of backlight, and can prevent degradation in image quality.

According to a first aspect of the present invention, there is provided a liquid crystal display device including a liquid crystal display panel, which includes a pair of substrates and a liquid crystal layer held between the pair of substrates, illumination means for illuminating the liquid crystal display panel, and a control unit which controls the liquid crystal display panel and the illumination means, the liquid crystal display panel comprising a plurality of display pixels which are arrayed in a matrix manner, and the control unit comprising: non-video signal insertion means for cyclically writing a video signal and a non-video signal as pixel voltages in each of the plurality of display pixels; synchronizing means for determining a turn-on timing or a turn-off timing of the illumination means in association with a timing at which the video signal or the non-video signal is written in the display pixels; and phase control means for changing a turn-on period of the illumination means and the turn-on timing of the illumination means.

According to a second aspect of the present invention, there is provided a driving method for a liquid crystal display device including a liquid crystal display panel, which includes a pair of substrates and a liquid crystal layer held between the pair of substrates, illumination means for illuminating the liquid crystal display panel, and a control unit which controls the liquid crystal display panel and the illumination means, the liquid crystal display panel including a plurality of display pixels which are arrayed in a matrix manner, the control unit cyclically writing a video signal and a non-video signal as pixel voltages in each of the plurality of display pixels; determining a turn-on timing or a turn-off timing of the illumination means in association with a timing at which the video signal or the non-video signal is written in the display pixels; and changing a turn-on period of the illumination means and the turn-on timing of the illumination means.

The present invention can provide a liquid crystal display device and a method of driving the liquid crystal display device, which can suppress variation in contrast of a display image due to dimming of backlight, and can prevent degradation in image quality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows an example of the structure of a liquid crystal display device according to an embodiment of the invention;

FIG. 2 is a view for describing an example of the structure of the liquid crystal display device shown in FIG. 1;

FIG. 3 is a view for describing an example of the structure of a backlight of the liquid crystal display device shown in FIG. 1;

FIG. 4 is a view for describing an example of the structure of a light emission part of the backlight of the liquid crystal display device shown in FIG. 1;

FIG. 5 is a view for describing a driving method for the backlight of the liquid crystal display device shown in FIG. 1;

FIG. 6 is a view for describing a driving method in a case of changing the turn-on period of a backlight of a prior-art liquid crystal display device;

FIG. 7 shows an example of the relationship between brightness and luminance in a case where the turn-on period of the backlight of the prior-art liquid crystal display device is changed;

FIG. 8 is a view for describing a driving method in a case of changing the turn-on period of the backlight of the liquid crystal display device shown in FIG. 1;

FIG. 9 shows an example of the relationship between brightness and luminance in a case where the turn-on period of the backlight of the liquid crystal display device shown in FIG. 1 is changed; and

FIG. 10 is a view for explaining an example of the relationship between the transmittance of a predetermined display pixel of the liquid crystal display device shown in FIG. 1 and the turn on/off timing of the turn-on area of the backlight, which corresponds to the display pixel.

### DETAILED DESCRIPTION OF THE INVENTION

An embodiment of the present invention will now be described with reference to the accompanying drawings.

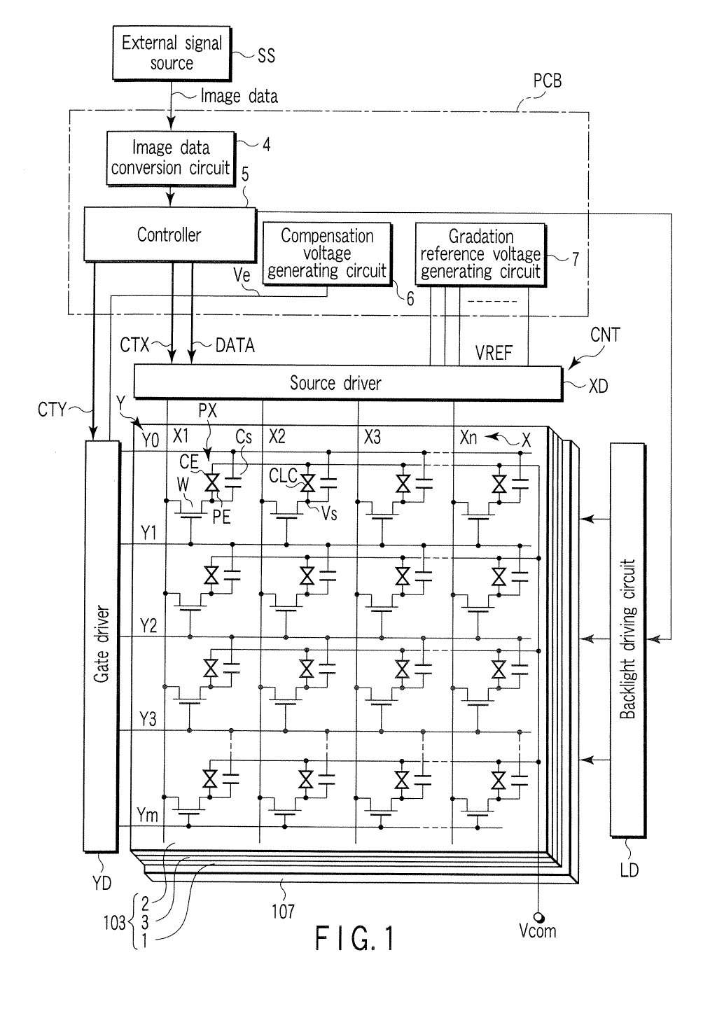

As is shown in FIG. 1, a liquid crystal display device according to the embodiment includes a liquid crystal display panel 103, a backlight 107 which illuminates the liquid crystal display panel 103, and a control unit CNT which controls the display panel 103 and backlight 107.

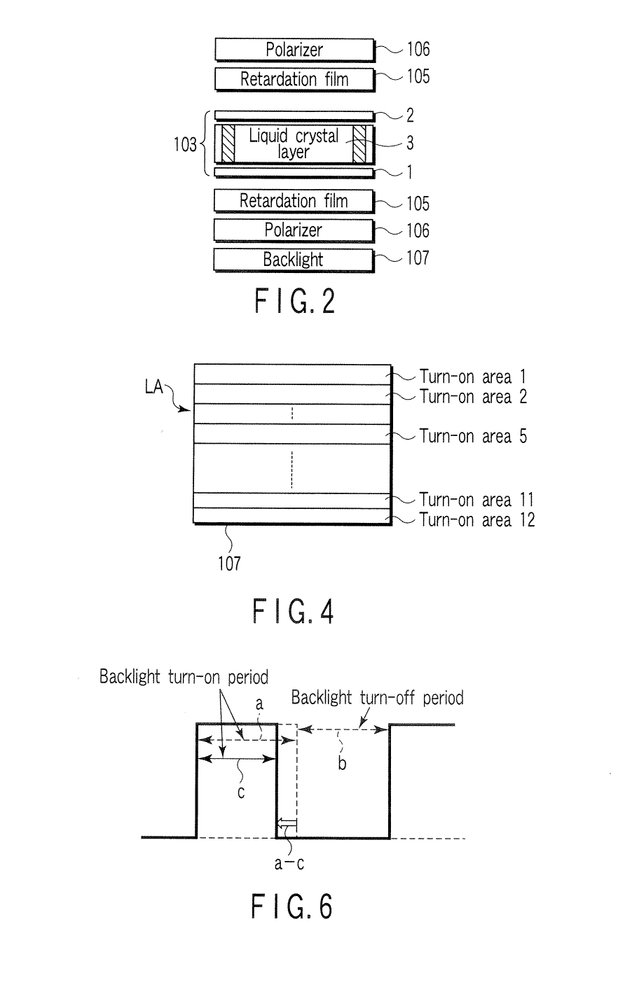

As shown in FIG. 1 and FIG. 2, the liquid crystal display panel 103 includes an array substrate 1, a counter-substrate 2, and a liquid crystal layer 3 which is held between the array substrate 1 and the counter-substrate 2. On the outer surface sides of the array substrate 1 and counter-substrate 2, there are provided retardation films 105, polarizers 106 and the backlight 107 functioning as illumination means.

The array substrate 1 includes a plurality of pixel electrodes PE which are arrayed substantially in a matrix manner on a transparent insulating substrate such as a glass substrate; a plurality of gate lines Y (Y0 to Ym) which are arranged along the rows of the plural pixel electrodes PE; a plurality of source lines X (X1 to Xn) which are arranged along the columns of the plural pixel electrodes PE; and a plurality of pixel switches W which are disposed near intersections of the gate lines Y and source lines X and are rendered conductive between the associated source lines X and associated pixel electrodes PE when the pixel switches W are driven via the associated gate lines Y.

The counter-substrate 2 includes a color filter (not shown) which is disposed on a transparent insulating substrate such as a glass substrate, and a counter-electrode CE which is disposed on the color filter so as to be opposed to the plural pixel electrodes PE.

Each of the pixel electrodes PE and the counter-electrode CE is formed of a transparent electrode material such as ITO (Indium Tin Oxide). The pixel electrodes PE and the common electrode CE are covered with a pair of alignment films (not shown) which are opposed to each other. In the liquid crystal display device according to this embodiment, the paired alignment films are subjected to rubbing treatment in mutually parallel directions. In addition, the alignment films are so designed that the pretilt angle of liquid crystal molecules included in the liquid crystal layer 3 may become about 10°.

The liquid crystal layer 3 of the liquid crystal display device according to this embodiment includes an OCB liquid crystal as a liquid crystal material. In other words, the liquid crystal display device of this embodiment is an OCB mode liquid crystal display device in which the liquid crystal molecules included in the liquid crystal layer 3 transition to a bend alignment when the liquid crystal display device is in a display state.

The OCB liquid crystal is transitioned in advance from a splay alignment to a bend alignment, for example, in order to perform a normally white display operation. Reverse transition from the bend alignment to splay alignment is prevented by a voltage for black display, which is cyclically applied. Each display pixel PX is constituted by the pixel electrode PE, the counter-electrode CE and the liquid crystal layer 3 that is interposed between these electrodes and is controlled to have an orientation of liquid crystal molecules corresponding to an electric field generated from these electrodes.

Each of the display pixels PX includes a storage capacitance Cs which is connected in parallel with a liquid crystal capacitance CLC between the associated pixel electrode PE and counter-electrode CE. In the liquid crystal display device of this embodiment, each storage capacitance Cs is constituted by capacitive coupling between the pixel electrode PE of the display pixel PX and a preceding-stage gate line Y which neighbors the display pixel PX on one side and controls the pixel switch W of the display pixel PX. Each storage capacitance Cs has a sufficiently high capacitance value, relative to parasitic capacitances of the pixel switch W, etc., so as to adequately compensate a potential variation in liquid crystal capacitance due to the influence of the parasitic capacitances of the pixel switch X, etc.

FIG. 1 omits depiction of a plurality of dummy pixels which are disposed around the matrix array of the pixels PX that constitute the display screen. The dummy pixels are wired similarly with the pixels PX within the display screen. The dummy pixels are provided in order to equalize the conditions of all pixels PX within the display screen with respect to, e.g. parasitic capacitances. The gate line Y0 is a gate line for the dummy pixels.

The control unit CNT controls the transmittance of the liquid crystal display panel 103 by a liquid crystal driving voltage that is applied to the liquid crystal layer 3 from the pixel electrodes PE of the array substrate 1 and the counter-electrode CE of the counter-substrate 2. The transition from the splay alignment to bend alignment of the liquid crystal molecules included in the liquid crystal layer 3 is executed by applying a relatively strong electric field to the OCB liquid crystal in a predetermined initializing process which is performed by the control unit CNT at the time of power-on.

The control unit CNT includes driving circuits XD and YD which drive the liquid crystal display panel 103, a backlight driving circuit LD which drives the backlight 107, a controller 5 which controls these driving circuits, and an image data conversion circuit 4.

The gate driver YD is connected to all gate lines Y, and sequentially drives the gate lines Y0 to Ym so as to turn on the pixel switches W on a row-by-row basis. The source driver XD is connected to all source lines X and outputs predetermined pixel voltages to the source lines X1 to Xn during a time period in which the pixel switches W of each row are turned on by the associated gate line Y.

The pixel voltages are voltages that are reversed in polarity at predetermined cycles with reference to a common voltage Vcom of the counter-electrode CE, and are applied to the associated pixel electrodes PE. In the liquid crystal display device of this embodiment, the pixel voltages are reversed in polarity, relative to the common voltage Vcom, so as to execute, e.g. a frame-reversal drive method and a line-reversal drive method.

The image data conversion circuit 4 executes conversion of, e.g. resolution and gradation of a plurality of image data, which are input from an external signal source SS to the pixels PX in every 1 frame period (vertical scanning period). The controller 5 controls, e.g. the operation timings of the gate driver YD and source driver XD in association with the image data that are obtained as a result of the conversion by the image data conversion circuit 4.

Specifically, the controller 5 outputs a control signal CTY which controls the timing at which the gate driver YD sequentially drives the gate lines Y; image data DATA; and a control signal CTX which controls the timing at which the source driver XD applies the pixel voltages to the associated source lines X.

The control unit CNT further includes a compensation voltage generating circuit 6 which generates a compensation voltage Ve, and a gradation reference voltage generating circuit 7 which generates a predetermined number of gradation reference voltages VREF. When the pixel switches W for one row are turned off, the compensation voltage Ve is applied via the gate driver YD to a preceding-stage gate line Y which neighbors, at one side, the gate line Y to which these pixel switches W are connected. Thereby, a variation in pixel voltages, which occurs in the pixels PX for one row due to parasitic capacitances of the pixel switches W, can be compensated. The gradation reference voltages VREF are used in order to convert the image data DATA to pixel voltages.

In the liquid crystal display device of this embodiment, the gate driver YD and source driver XD are, for instance, integrated circuit (IC) chips which are disposed on the outside of the display pixels PX along outer edge parts of the array substrate 1. On the other hand, the image data conversion circuit 4 and controller 5 are disposed on an external printed circuit board PCB.

Next, a method of driving the liquid crystal display panel 103 is described.

If image data is output from the external signal source SS to the control unit CNT, the image data is input to the image data conversion circuit 4. The image data conversion circuit 4 outputs, in every 1 horizontal scanning period, a conversion result of image data DATA for the display pixels PX of one row. The image data, which is the conversion result of the image data conversion circuit 4, is output to the controller 5.

The controller 5 outputs the control signal CTY for sequentially driving the gate lines Y. In addition, the controller 5 assigns to the source lines X the image data DATA that are obtained in units of one-row display pixels PX as the conversion result of the image data conversion circuit 4 and are serially output. The controller 5 also generates the control signal CTX for designating the output polarity, etc.

The control signal CTY, which is output from the controller 5, is supplied to the gate driver YD. The control signal CTX, which is output from the controller 5, is supplied to the source driver XD together with the image data DATA that are obtained as the conversion result of the image data conversion circuit 4.

The gate driver YD sequentially selects the gate lines Y1 to Ym in 1 frame period under the control of the control signal CTY, and supplies a selected one of the gate lines Y with an ON voltage for turning on the pixel switches W of the associated row during only 1 horizontal scanning period.

The source driver XD converts the image data DATA, which are output from the controller 5, to pixel voltages with reference to the predetermined number of gradation reference voltages VREF that are supplied from the above-described gradation reference voltage generating circuit 7, and outputs the pixel voltages to the source lines X1 to Xn in a parallel fashion.

If the gate driver YD drives, for instance, the gate line Y1 by the ON voltage and turns on all the pixel switches W that are connected to the gate line Y1, the pixel voltages on the source lines X1 to Xn are supplied via the pixel switches W to the associated pixel electrodes PE and one-end terminals of the storage capacitances Cs.

At this time, the source driver XD cyclically outputs a video signal and a non-video signal as pixel voltages to the source lines X1 to Xn. In the liquid crystal display device of this embodiment, a black-level signal (black signal), which serves as the non-video signal, is output as the pixel voltages to the source lines X1 to Xn.

In short, the gate driver YD drives the gate line Y and turns on all the pixel switches W that are associated with the driven gate line Y, and the source driver XD drives the source lines X1 to Xn and cyclically outputs the video signal and black signal as pixel voltages to the associated display pixels PX. Thus, the video signal and black signal are cyclically written in the associated display pixels PX.

In the case of the liquid crystal display device of this embodiment, the ratio of a black display period, in which the black signal is written to create a black display state, to 1 frame period is 30%. That is, the ratio of the black display period to 1 frame period is 30%, and the ratio of the video display period for displaying an image is 70%.

The gate driver YD also outputs the compensation voltage Ve, which is generated from the compensation voltage generating circuit 6, to the preceding-stage gate line Y0 which neighbors the gate line Y1, and turns on all the pixel switches W connected to the gate line Y1 during only 1 horizontal scanning period. Immediately thereafter, the gate driver YD outputs an OFF voltage to the gate line Y1 to turn off these pixel switches W.

When the pixel switches W are turned off, the compensation voltage Ve reduces the amount of charge that is to be extracted from the pixel electrodes PE due to the parasitic capacitances of the pixel switches W, thereby substantially canceling a variation in the pixel voltage, that is, a field-through voltage.

Next, the structure of the backlight 107 of the liquid crystal display device according to this embodiment and the driving method of the backlight 107 are described.

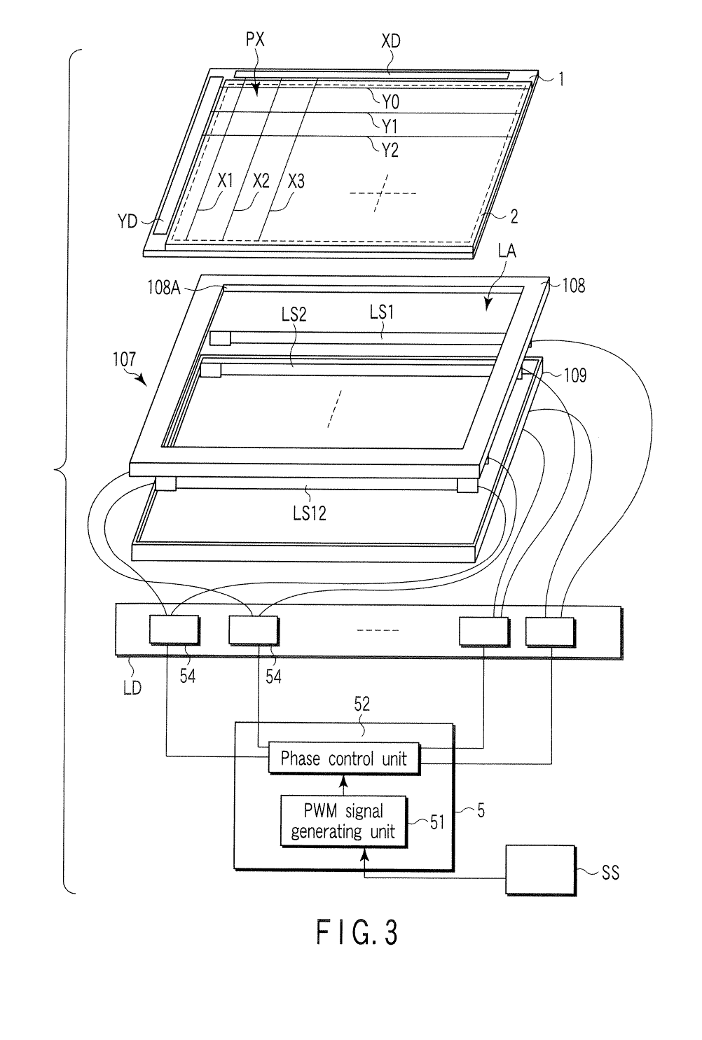

As is shown in FIG. 3, the backlight 107 of the liquid crystal display device according to this embodiment includes a plurality of cold-cathode fluorescent tubes LS (LS1 to LS12) functioning as light sources, a back cover 109 which supports the cold-cathode fluorescent tubes LS, and a top cover 108 which engages the back cover 109 and has a substantially rectangular window part 108A which defines a light emission part LA for emitting light.

In the backlight 107 of the liquid crystal display device according to this embodiment, each of the cold-cathode fluorescent tubes LS constitutes a turn-on area corresponding to display pixels of a plurality of rows. Specifically, as shown in FIG. 4, the light emission part LA of the backlight 107 is divided into a plurality of turn-on areas. In the case of the liquid crystal display device of this embodiment, since the backlight 107 comprises twelve cold-cathode fluorescent tubes LS (LS1 to LS12), the light emission part LA is divided into twelve turn-on areas corresponding to the cold-cathode fluorescent tubes LS (LS1 to LS12).

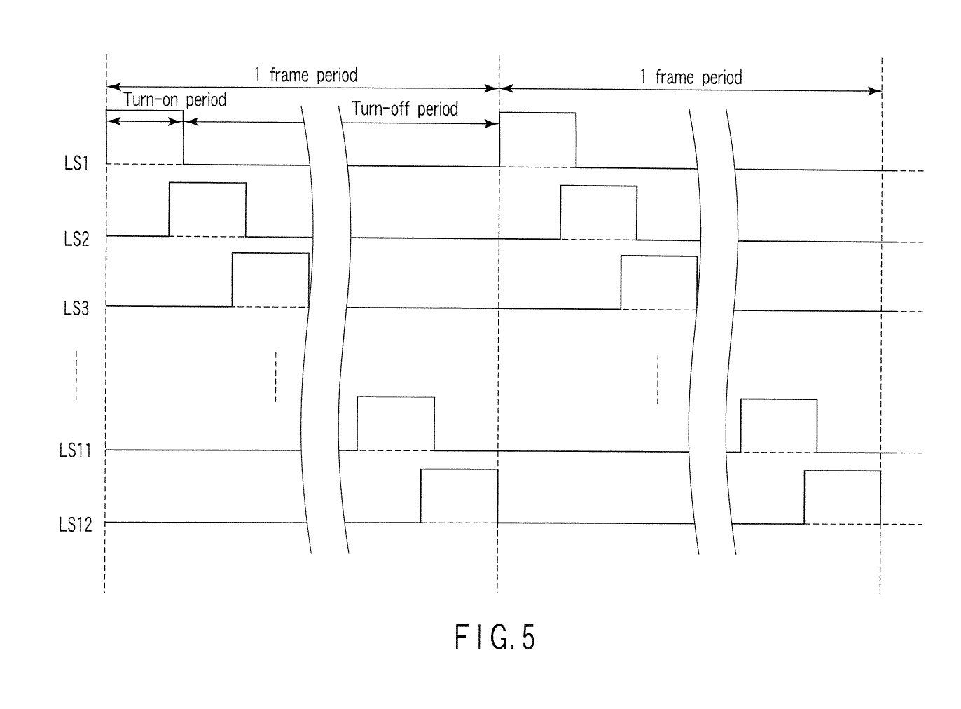

The 12 cold-cathode fluorescent tubes LS1 to LS12 are controlled to be sequentially turned on/off at predetermined timings in accordance with dimmer pulses, as shown in FIG. 5. Accordingly, the 12 turn-on areas corresponding to the 12 cold-cathode fluorescent tubes LS1 to LS12 are also controlled to be sequentially turned on/off at predetermined timings. In short, the backlight 107 of the liquid crystal display device according to this embodiment is a blinking backlight.

Although not shown, the backlight 107 includes optical sheets such as a reflection sheet which reflects, for instance, light that is emitted from the cold-cathode fluorescent tubes LS to the back cover 109 side, toward the liquid crystal display panel 103 side, and a diffusion sheet which diffuses light that is emitted from the cold-cathode fluorescent tubes LS.

The plural cold-cathode fluorescent tubes LS are driven by the backlight driving circuit LD, and the operation of the backlight driving circuit LD is controlled by the controller 5. The controller 5 includes a PWM signal generating unit 51 and a phase control unit 52. The PWM signal generating unit 51 detects a duty ratio from a PWM dimmer signal that is input from the external signal source SS, and outputs, on the basis of the detection result, a dimmer pulse, which is set at a predetermined duty ratio (backlight duty), to the phase control unit 52.

In the liquid crystal display device of the present embodiment, as described above, in 1 frame period, the ratio of the black display period is 30% and the ratio of the video display period, in which an image is displayed, is 70%. On the other hand, the backlight duty is set at 50% in 1 frame period. That is, in 1 frame period, the ratio of the period in which the backlight 107 is turned on is 50%, and the ratio of the period in which the backlight 107 is turned off is 50%. Specifically, although the ratio of the video display period is 70%, the turn-on period of the backlight 107 is 50%, and thus the turn-on period of the backlight 107 is short, relative to the ratio of the video display period.

When the backlight duty is to be set, it is preferable to set the ratio of the turn-on period of the backlight 107 to be less than the video display ratio of the liquid crystal display panel 103 (100%—black insertion ratio) since this setting can enhance the contrast of the display image. In other words, if the ratio of the turn-on period of the backlight 107 is greater than the video display ratio (100%—black insertion ratio), an undesired image, other than a display image corresponding to the video signal, may possibly be displayed. As a result, the contrast may deteriorate and the display quality may be degraded.

The phase control unit 52 controls the phases of the dimmer pulses that are input from the PWM signal generating unit 51, and outputs the dimmer pulses to the backlight driving circuit LD. Specifically, the phase control unit 52 is a synchronizing means for controlling the phases of dimmer pulses so that the timing at which the plural cold-cathode fluorescent tubes LS are turned on/off may be synchronized with the timing at which predetermined display pixels PX that are illuminated by the associated turn-on areas of the cold-cathode fluorescent tubes LS are set in the video display state or in the black display state.

In the liquid crystal display device of this embodiment, the timing, at which the display pixels PX are set in the video display state or in the black display state, is a timing that substantially coincides with the timing at which the write of the video signal or black signal in the display pixels is started.

The backlight driving circuit LD includes inverters 54 which are connected to the plural cold-cathode fluorescent tubes LS. The dimmer pulses, the phases of which have been controlled by the phase control unit 52, are output to the associated inverters 54. Each inverter 54 converts the input dimmer pulse to a voltage, and controls the turning on/off of the associated cold-cathode fluorescent tube LS in accordance with the duty ratio of the input dimmer pulse.

Next, the method of driving the backlight 107 is described.

A PWM dimmer signal is input from the external signal source SS to the PWM signal generating unit 51 of the controller 5. The PWM signal generating unit 51 detects the duty ratio of the input PWM dimmer signal, and outputs dimmer pulses to the phase control unit 52. At this time, the PWM signal generating unit 51 also outputs a sync signal with non-video signal write and video signal write to the phase control unit 52.

In accordance with the input dimmer pulses and sync signal, the phase control unit 52 controls the phases of the dimmer pulses so that the timing, at which the plural cold-cathode fluorescent tubes LS are turned on/off, may be synchronized with the timing at which predetermined display pixels PX that are illuminated by the associated turn-on areas of the cold-cathode fluorescent tubes LS are set in the video display state or in the black display state.

In other words, as shown in FIG. 5, the phase control unit 52 outputs dimmer pulses, the phases of which are shifted in accordance with the timing signal input from the PWM signal generating unit 51, to the inverters 54 which apply voltages to the cold-cathode fluorescent tubes LS. The respective inverters 54 convert the input dimmer pulses to voltages, and controls the turning on/off of the associated cold-cathode fluorescent tubes LS in accordance with the input dimmer pulses.

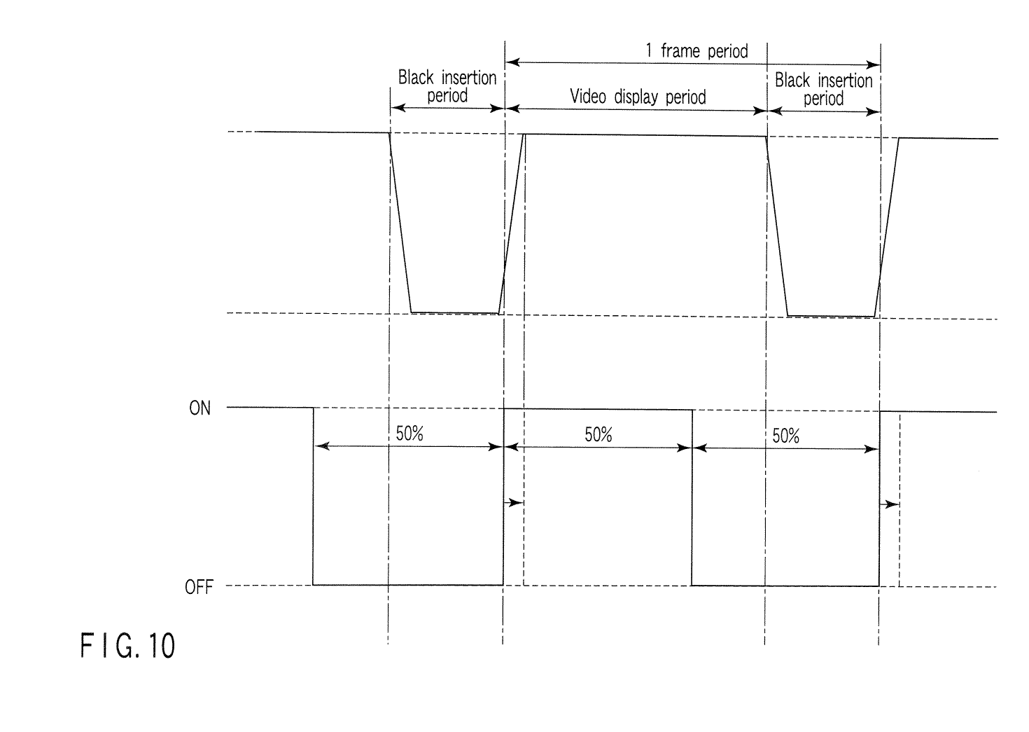

Thereby, the turn-on areas that are associated with the cold-cathode fluorescent tubes LS are turned on/off in sync with the timing at which predetermined display pixels PX are set in the video display state or black display state. In the liquid crystal display device of this embodiment, as shown in FIG. 10, the cold-cathode fluorescent tubes LS are controlled such that the timing at which predetermined display pixels PX are set in the video display state is synchronized with the timing at which the cold-cathode fluorescent tubes LS are turned on.

In the prior art, when the turn-on time of the backlight 107 is shortened to decrease the luminance of the backlight 107, the dimming control for the backlight 107 is executed as follows. Assume now that a turn-on period a and a turn-off period b of each cold-cathode fluorescent tube LS of the backlight 107 are set.

In this case, in the prior art, when the turn-on period a of the backlight 107 is to be shortened, the turn-off timing of each turn-on area of the backlight 107 is set to be earlier than the pre-change turn-off timing.

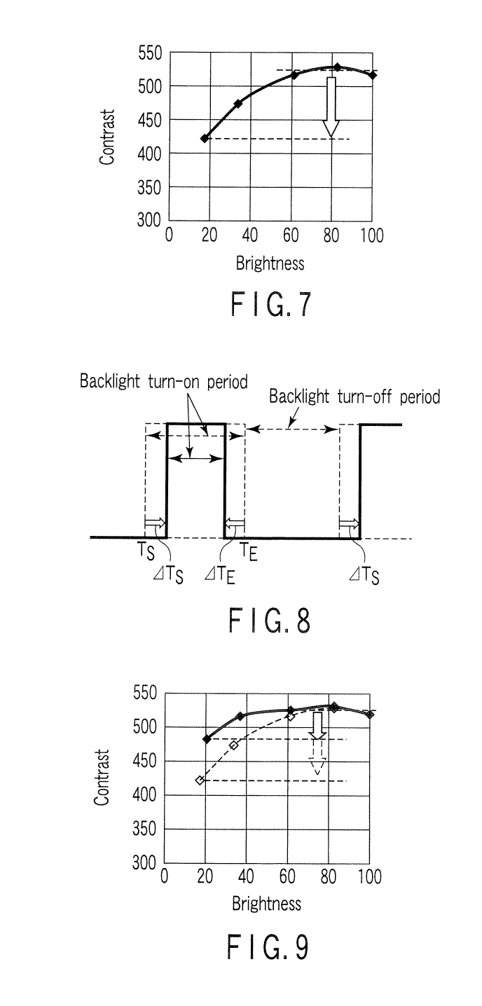

To be more specific, as shown in FIG. 6, when the backlight duty is changed to a smaller value, the phase control unit 52 changes the backlight turn-on period a to a shorter backlight turn-on period c (a>c) and makes the turn-off timing of each cold-cathode fluorescent tube LS earlier by a predetermined period a-c. When the turn-off period of the backlight is shortened as described above, the contrast, as a result, may greatly decrease in some cases, as shown in FIG. 7.

On the other hand, in the liquid crystal display device according to the present embodiment, the controller 5 controls the backlight 107 via the backlight driving circuit LD so that the contrast of the display image may not greatly decrease even if the turn-on period of the backlight 107 is shortened.

Specifically, in the liquid crystal display device of this embodiment, the turn-on period of the backlight 107 is shortened as shown in FIG. 8. In the liquid crystal display device of this embodiment, not only the turn-on period of the backlight but also the turn-on timing of the backlight is changed.

As shown in FIG. 8, in the case where the turn-on period of the backlight 107 is to be shortened when the backlight duty is set at 50%, the phase control unit 52 of the controller 5 delays the rising timing (turn-on timing) of the dimmer pulse, relative to the turn-on timing before the change of the turn-on period. In the example shown in FIG. 8, the turn-on timing T_{S} before the change of the turn-on period is delayed by a first period ΔT_{S}.

Further, the phase control unit 52 makes the falling timing (turn-off timing) of the dimmer pulse earlier than the turn-off timing before the change of the turn-on period. In the example shown in FIG. 8, the turn-off timing T_{E} before the change of the turn-on period is made earlier by a second period ΔT_{E}.

In the liquid crystal display device according to this embodiment, as described above, when the turn-on period of the backlight 107 is shortened, both the rising timing and falling timing of the dimmer pulse are changed. Specifically, the PWM signal generating unit 51 outputs the dimmer pulse with a desired backlight duty. The phase control unit 52 is phase control means for outputting the dimmer pulse which changes the turn-on timing and turn-off timing of each cold-cathode fluorescent tube LS of the backlight 107 and also changes the turn-on period of each cold-cathode fluorescent tube LS so as to correspond to the backlight duty ratio.

In the liquid crystal display device of this embodiment, the first period ΔT_{S} and the second period ΔT_{E} shown in FIG. 8 are substantially equal. For example, in the case where the backlight duty is changed from 50% to 40%, the phase control unit 52 sets the first period ΔT_{S} shown in FIG. 8 at 5% and sets the second period ΔT_{E} at 5%. In the case where the backlight duty is changed from 50% to 30%, the phase control unit 52 sets the first period ΔT_{S} shown in FIG. 8 at 10% and sets the second period ΔT_{E} at 10%.

If the controller 5 changes the turn-on timing and turn-off timing of the backlight 107 as described above, a decrease in contrast is suppressed, as shown in FIG. 9, even in the case where the turn-on period of the backlight 107 is shortened to decrease the luminance.

To be more specific, as shown in FIG. 10, when the black display period transitions to the video display period, a predetermined time is needed until the transmittance of the display pixel PX that is positioned on a predetermined row increases to a value corresponding to the pixel voltage.

For example, as shown in FIG. 10, in the case where the turn-on timing and turn-off timing of each turn-on area of the backlight 107 are to be set, that is, in the case where the start timing of the video display period of the liquid crystal display panel 103 is to be synchronized with the turn-on timing of the backlight 107, if the turn-on timing of each turn-on area is delayed relative to the pre-change timing, each turn-on area can be turned on after the transmittance of the display pixel PX has increased to a desired value.

Thus, if the turn-on timing of each turn-on area is changed, as described above, when the turn-on period of the backlight 107 is to be shortened, the backlight 107 is turned on after the transmittance of the display pixel PX has increased to a sufficiently high value. Therefore, a decrease in white luminance of the display image can be suppressed.

As a result, a decrease in contrast of the display image can be suppressed by changing the turn-on timing of the backlight 107 as described above.

In the liquid crystal display device of this embodiment, the first period ΔT_{S} and the second period ΔT_{E} are set to be substantially equal, as described above. Thereby, a variation in contrast due to the dimming control can be decreased more effectively.

Specifically, in the liquid crystal display device of this embodiment, the dimmer pulses are synchronized so that each of the turn-on areas of the backlight 107 is turned on in association with the video display period, as described above.

Normally, each turn-on area of the backlight 107 illuminates display pixels PX of a plurality of rows. In the liquid crystal display device of this embodiment, for example, the turn-on/off timings of each turn-on area of the backlight 107 are set to be synchronized with the video display period and black insertion period of a central row of the associated rows of display pixels PX.

Consequently, when the turn-on period of the plural cold-cathode fluorescent tubes LS1 to LS12 of the backlight 107 is to be shortened, if only the turn-on timing of each cold-cathode fluorescent tube LS of the backlight 107 is delayed, the balance of illumination varies between an upper part and a lower part of the central one of the associated rows of display pixels, which correspond to the respective turn-on areas.

For example, in the upper part, the period in which the backlight 107 is turned off increases in the video display period. This results in non-uniformity in display between the upper part and lower part of the display pixels of the associated plural rows, which correspond to the respective turn-on areas. In addition, the white luminance of the display image decreases, and the contrast decreases.

Thus, in the liquid crystal display device of this embodiment, the first period ΔT_{S} and the second period ΔT_{E} are set to be substantially equal, taking into account the response period of the display pixels to the pixel voltages and the balance of illumination between the upper part and lower part of the display pixels of the plural rows corresponding to the respective turn-on areas.

As has been described above, in the liquid crystal display device and the driving method thereof according to the embodiment of the invention, the turn-on period of the backlight 107 and the turn-on timing of the backlight 107 are changed when the dimming control is executed. Thereby, a variation in contrast of the liquid crystal display panel 103 due to the dimming control can be decreased, and a variation in image quality of the display image can be suppressed.

The present invention is not limited directly to the above-described embodiment. In practice, the structural elements can be modified without departing from the spirit of the invention.

For example, in the liquid crystal display device of the above-described embodiment, the black insertion ratio is set at 30% and the backlight duty is set at 50%. However, the black insertion ratio and backlight duty are not limited to these values, and may be variable. In the case of the liquid crystal display device using the OCB liquid crystal, the black insertion driving method is adopted as a reverse-transition prevention driving scheme for preventing reverse transition from the bend alignment to splay alignment. Since the ease in occurrence of reverse transition varies depending on temperatures, it may be possible, for example, to detect the panel temperature, vary the black insertion ratio on the basis of the detection result and vary the backlight duty in association with the black insertion ratio.

In the liquid crystal display device of this embodiment, the first period ΔT_{S} and the second period ΔT_{E} are set to be substantially equal. However, the first period ΔT_{S} may be set to be greater than the second period ΔT_{E}. When the black display period transitions to the video display period, the transmittance of the display pixel PX varies as shown in FIG. 10. In short, a response to the application of the pixel voltage requires a fixed length of time.

In the case of the liquid crystal display device of this embodiment, the OCB liquid crystal is used as the liquid crystal material and thus a high-speed response is enabled. However, in a case of adopting a liquid crystal mode with a long response time from the application of the pixel voltage, even if the first period ΔT_{S} and the second period ΔT_{E} are set to be substantially equal, such a problem may arise that due to a long response time of the liquid crystal, the transmittance of the display pixel PX fails to reach a desired value when the backlight is turned on.

In such a case, the first period ΔT_{S} is set to be greater than the second period ΔT_{E}. Thereby, the backlight 107 is not turned on until the transmittance of the display pixel PX reaches a desired value, and non-uniformity in luminance is hardly visually recognized at the time when the backlight 107 is turned on. Moreover, the degradation in display image, for example, a decrease in contrast, can be suppressed.

In the above-described embodiment, the cold-cathode fluorescent tube LS is used as the light source of the backlight 107. Alternatively, an LED light source may be used. In this case, the relationship between the responsivity of the liquid crystal and the rising of turn-on of the light source will differ from the case of using the cold-cathode fluorescent tube LS as the light source. However, the same advantages can be obtained by applying the present invention.

Various inventions can be made by properly combining the structural elements disclosed in the embodiment. For example, some structural elements may be omitted from all the structural elements disclosed in the embodiment. Furthermore, structural elements in different embodiments may properly be combined.

What is claimed is:

1. A liquid crystal display device including a liquid crystal display panel, which includes a pair of substrates and a liquid crystal layer held between the pair of substrates, illumination means for illuminating the liquid crystal display panel, and a control unit which controls the liquid crystal display panel and the illumination means,
the liquid crystal display panel comprising a plurality of display pixels which are arrayed in a matrix manner, and
the control unit comprising:
non-video signal insertion means for cyclically writing a video signal and a non-video signal as pixel voltages in each of the plurality of display pixels;
synchronizing means for determining a turn-on timing or a turn-off timing of the illumination means in association with a timing at which the video signal or the non-video signal is written in the display pixels; and
phase control means for changing a turn-on period of the illumination means and the turn-on timing of the illumination means.

2. The liquid crystal display device according to claim 1, wherein the phase control means includes means for delaying the turn-on timing of the illumination means, relative to a pre-change timing, when the turn-on period of the illumination means in 1 frame period is changed to be shorter.

3. The liquid crystal display device according to claim 1, wherein the phase control means includes means for delaying the turn-on timing of the illumination means, relative to a timing at which the video signal is written in predetermined ones of the plurality of display pixels, when the turn-on period of the illumination means in 1 frame period is changed to be shorter.

4. The liquid crystal display device according to claim 1, wherein in the 1 frame period, a turn-on period of the illumination means is shorter than a period in which an image corresponding to the video signal is displayed on the display pixels.

5. The liquid crystal display device according to claim 1, wherein the illumination means includes a plurality of turn-on areas, and
the phase control means includes means for changing a turn-on period of each of the turn-on areas and a turn-on timing of each of the turn-on areas.

6. The liquid crystal display device according to claim 5, wherein the phase control means includes means for delaying the turn-on timing of each of the turn-on areas, relative to a pre-change timing, when the turn-on period of the illumination means in 1 frame period is changed to be shorter.

7. The liquid crystal display device according to claim 5, wherein the phase control means includes means for delaying the turn-on timing of each of the turn-on areas, relative to a timing at which the video signal is written in predetermined ones of the plurality of display pixels corresponding to the turn-on areas, when the turn-on period of the illumination means in 1 frame period is changed to be shorter.

8. The liquid crystal display device according to claim 1, wherein the illumination means includes a plurality of light sources, and
the phase control unit includes means for changing a turn-on period of each of the light sources and a turn-on timing of each of the light sources.

9. The liquid crystal display device according to claim 1, wherein the control unit includes means for setting liquid crystal molecules of the liquid crystal layer in a bend alignment, thereby to set the liquid crystal display panel in a display state.

10. The liquid crystal display device according to claim 1, wherein the phase control means includes means for changing the turn-on period of the illumination means by varying a pulse width of a dimmer signal, and
the means for changing the turn-on period of the illumination means includes means for delaying a rising timing of the dimmer signal, relative to a pre-change rising timing, and making a falling timing of the dimmer signal earlier than a pre-change falling timing, when the turn-on period of the illumination means is changed to be shorter.

11. The liquid crystal display device according to claim 10, wherein a period, by which the rising timing of the dimmer signal is delayed, is substantially equal to a period by which the falling timing of the dimmer signal is made earlier.

12. The liquid crystal display device according to claim 10, wherein a period, by which the rising timing of the dimmer signal is delayed, is greater than a period by which the falling timing of the dimmer signal is made earlier.

13. A driving method for a liquid crystal display device including a liquid crystal display panel, which includes a pair of substrates and a liquid crystal layer held between the pair of substrates, illumination means for illuminating the liquid crystal display panel, and a control unit which controls the liquid crystal display panel and the illumination means, the liquid crystal display panel including a plurality of display pixels which are arrayed in a matrix manner, the control unit cyclically writing a video signal and a non-video signal as pixel voltages in each of the plurality of display pixels;
determining a turn-on timing or a turn-off timing of the illumination means in association with a timing at which the video signal or the non-video signal is written in the display pixels; and
changing a turn-on period of the illumination means and the turn-on timing of the illumination means.

14. The driving method for a liquid crystal display device, according to claim 13, wherein the control unit delays the turn-on timing of the illumination means, relative to a pre-change timing, when the turn-on period of the illumination means is changed to be shorter.

15. The driving method for a liquid crystal display device, according to claim 13, wherein the control unit delays the turn-on timing of the illumination means, relative to a timing at which the video signal is written in predetermined ones of the plurality of display pixels, when the turn-on period of the illumination means is changed to be shorter.

16. The driving method for a liquid crystal display device, according to claim 13, wherein the control unit sets a turn-on period of the illumination means to be shorter, in 1 frame period, than a period in which the video signal is displayed.

17. The driving method for a liquid crystal display device, according to claim 13, wherein the illumination means includes a plurality of turn-on areas, and
the control unit changes a turn-on period of each of the plurality of turn-on areas and a turn-on timing of each of the plurality of turn-on areas.

18. The driving method for a liquid crystal display device, according to claim 14, wherein the control unit delays the turn-on timing of each of the plurality of turn-on areas, relative to a pre-change timing, when the turn-on period of the illumination means is changed to be shorter.

19. The driving method for a liquid crystal display device, according to claim 14, wherein the control unit delays the turn-on timing of each of the plurality of turn-on areas, relative to a timing at which the video signal is written in predetermined ones of the plurality of display pixels corresponding to the plurality of turn-on areas, when the turn-on period of the illumination means is changed to be shorter.

20. The driving method for a liquid crystal display device, according to claim 11, wherein the control unit sets liquid crystal molecules included in the liquid crystal layer in a bend alignment, thereby to set the liquid crystal display panel in a display state.

21. The driving method for a liquid crystal display device, according to claim 11, wherein the control unit controls turning on/off of the illumination means by varying a pulse width of a dimmer signal, and
the control unit delays a rising timing of the dimmer signal, relative to a pre-change rising timing, and makes a falling timing of the dimmer signal earlier than a pre-change falling timing, when the turn-on period of the illumination means is changed to be shorter.

22. The driving method for a liquid crystal display device, according to claim 21, wherein the control unit sets a period, by which the rising timing of the dimmer signal is delayed, to be substantially equal to a period by which the falling timing of the dimmer signal is made earlier.

23. The driving method for a liquid crystal display device, according to claim 21, wherein the control unit sets a period, by which the rising timing of the dimmer signal is delayed, to be greater than a period by which the falling timing of the dimmer signal is made earlier.
